(19) United States
(12) Patent Application Publication
(10) Pub. No.: US 2021/0101503 A1
(43) Pub. Date: Apr. 8, 2021

(54) ADAPTIVE VEHICLE POWER SYSTEM

(71) Applicant: Michael E. Windsor, Pittsburg, KS (US)

(72) Inventor: Michael E. Windsor, Pittsburg, KS (US)

(21) Appl. No.: 17/063,032

(22) Filed: Oct. 5, 2020

Related U.S. Application Data
(60) Provisional application No. 62/910,570, filed on Oct. 4, 2019.

(51) Int. Cl. B60L 58/22; H02J 7/14; B60L 50/61; H02J 7/00; B60W 10/26

(52) U.S. Cl. CPC B60L 58/22; H02J 7/1423; B60L 50/61; H02J 2207/10; H02J 7/00712; B60W 10/26; H02J 7/0024

(57) ABSTRACT

An adaptive vehicle power system provides an interface between a vehicle twelve-volt electrical system and a twelve, twenty-four, thirty-six or higher voltage battery bank for a vehicle load, such as a motor or other device, to allow operation of the load using the battery bank. In one embodiment, the adaptive vehicle power system automatically senses when the vehicle electrical system is operating properly and automatically switches into a charging mode to charge the battery bank from the vehicle electrical system.

### CROSS-REFERENCE TO RELATED APPLICATIONS

This application claims the benefit of U.S. Provisional Patent Application No. 62/910,570, filed Oct. 4, 2019, the disclosure of which is hereby incorporated herein in its entirety by reference.

### BACKGROUND

Operation and use of a vehicle often involves the use of separate electric powered accessories that are not directly compatible with the vehicle's integrated electrical system. Normally, the vehicle's electrical power system is matched directly to the vehicle's needs for starting the vehicle drive motor and operating the vehicle at its normal operating voltage, with the on-board capability to provide adequate power to the vehicle during operation, and additional power to recharge or replenish the vehicle's energy storage devices (e.g., Battery(s)), so that the vehicle can be re-started and operated as needed. A typical incompatibility of such accessories used with vehicles is that they operate on a different voltage than the vehicle's power system provides. Because of this voltage incompatibility, the vehicle's electrical system cannot typically be used to directly power the accessory or to recharge the battery(s) of the accessory. Thus, the use of such an accessory in conjunction with the vehicle usually requires the use of a separate (isolated) power supply or energy storage device (e.g., Battery(s)) and electrical system for that accessory.

One such example of an incompatibility occurs in the field of boating. The standard electrical system of larger boats having either inboard or outboard motor(s), normally referred to as fuel driven ‘drive’ motor(s), is twelve volts DC (similar to a standard twelve volt DC automobile electrical system). A common boat accessory now being used extensively is an electric powered Trolling motor. Trolling motors are used for precise directional control of the boat at relatively slow speeds. Trolling motors are available in various shapes and sizes and operate on multiple voltage levels, relative to their level of performance offered in power, torque, and duration of operation. The larger the boat, the higher the performance is required from the Trolling motor to properly control and maneuver the boat as required by the operator.

As performance requirements increase, larger electrical motors are required to provide the power needed. These electrical Trolling motors often use a twelve, twenty-four, thirty-six, or even higher voltage electrical system to operate them. The energy required to power these motors is normally supplied by energy storage devices, comprising a bank of batteries, separate from the drive motor batteries on-board the vessel, typically one twelve volt battery for a twelve volt system, two twelve volt batteries in a series circuit arrangement for twenty-four volt systems, three twelve volt batteries in a series circuit arrangement for thirty-six volt systems and so on. The energy storage devices (the bank of batteries) for the Trolling motor is contained separately from the boat's electrical system. This is true, even if the vessel's electrical system is at the same voltage as the Trolling motor, (i.e. the twelve volt Trolling motor with a twelve volt drive motor electrical system), the systems are isolated from one another, so as not to use power from or deplete the drive motor's energy storage devices. To do so, could render the vessel inoperable and unable to start or properly operate its fuel driven drive motor, thus stranding the vehicle (boat) and its operator on the water.

This intentional separation of electrical systems between the drive motor and its battery system and the Trolling motor and its battery system, forces the need for a completely separate charging system for the Trolling motor battery system, which are now most often charged from land utility power while the boat is docked, moored, or in storage, with the vessel itself having no capability for charging the Trolling motor battery or bank of batteries from the boat's electrical system, either while the boat is actually operating on the water or while the boat is docked or moored without access to utility electrical power from land.

Because the Trolling motor batteries and the electrical system of the Trolling motor are entirely separate from the boat's twelve volt electrical system, the boat's electrical system cannot be used to power the Trolling motor and cannot be used to recharge the batteries of the Trolling motor system. Likewise, the Trolling motor electrical system and/or its bank of batteries cannot be used to power or supplement the boat's electrical system.

In another example of incompatibility of various voltages between vehicles and accessory systems, most military vehicles require twenty-four volts for their normal operation, utilizing a twenty-four volt battery system and a twenty-four volt electrical generating system powered by the fuel driven vehicle motor. Some military communication equipment (accessory) on-board the vehicle may require forty-eight volts for their normal operation using an on-board forty-eight volt battery system which is incompatible with the vehicle's electrical system, resulting in the same dilemma as previously described above. In some cases, the operator is supplied with a solar panel array (accessory), which is comprised of multiple twelve volt panels, which is to be used as a separate power system for the communication equipment at forty-eight volts and then reconfigured as a recharging system for the vehicle batteries at twenty-four volts. There does not exist a functional system that can easily interconnect these accessories with the vehicle in a functional and practical manner.

From these examples of incompatibility of the various voltage systems of various vehicles and accessories, one skilled in the art can easily derive that there remains a need in the art for a portable electrical power system that overcomes these deficiencies of the prior art and provides flexibility to users of accessories in the boating industry, in the military, and in other vehicle power systems, that eliminates these incompatibilities and provides compatible voltage and power levels to the various accessories or various power systems as required by the user.

### SUMMARY

Embodiments of the invention are defined by the claims below, not this summary. A high-level overview of various aspects of the invention is provided here to introduce a selection of concepts that are further described in the detailed description section as follows. This summary is not intended to identify key features or essential features of the claimed subject matter, nor is it intended to be used in isolation to determine the scope of the claimed subject matter. In brief, this disclosure describes, among other things, embodiments of the creation of an adaptive vehicle power system that solves these problems of incompatibility.

In one aspect, the adaptive vehicle power system invention provides an interface between a twelve, twenty-four, thirty-six or higher voltage battery bank/power system for a Trolling motor and a boat's twelve volt electrical system. In another aspect, when the boat's drive motor(s) is operated, the adaptive vehicle power system automatically senses that the boat's motor(s) is operating properly and the motor's electrical system is producing a charge voltage and then automatically switches into a charging mode.

In this aspect, the adaptive vehicle power system allows the boat's drive motor alternator/generator electrical charging system to individually charge the battery(s) of the twelve, twenty-four, thirty-six, or higher voltage battery bank from the twelve volt electrical system of the boat drive motor(s) with which it is being used. All batteries in the Trolling motor battery bank that were previously electrically configured in a series circuit arrangement resulting in a higher voltage required by the proper operation of the Trolling motor, are now switched and re-configured by the adaptive vehicle power system into a parallel circuit arrangement, wherein all batteries are seen as twelve volt batteries and thus can be connected to and charged by the boat's drive motor(s)'s twelve volt electrical system. At the same time, with the action of the adaptive vehicle power system switching into charge mode, the system can also be configured to automatically disable the Trolling motor (or other load) from being operated while the boat's drive motor(s) is operating, thus adding an aspect of additional safety to the boat operator. At the same time, with the action of the adaptive vehicle power system switching into charge mode, the boat's drive motor electrical battery system can also be charged by the boat's drive motor(s)'s twelve volt electrical system, replenishing the energy needed for starting and operating the boat during its next future operation.

In another aspect, the adaptive vehicle power system can be temporarily enabled by the operator, to switch all battery systems into parallel circuit mode providing a twelve volt output which can then be used to reverse power to the boat's drive motor battery system or to the boat's drive motor itself (without a drive motor battery in the circuit). In this aspect, all the power reserve of the Trolling motor batteries would now be available to the boat's twelve volt electrical system and can be used to emergency jump start the boat's drive motor. This emergency boost jump start ability of the adaptive vehicle power system would be of great benefit to vessels that were stranded with a dead or depleted drive motor battery, providing them with an emergency alternative power source for the boat's drive motor(s). If for any reason the boat's drive motor(s) would not function, this power reserve could be used for operating other systems on the boat, like radios, transponders, search lights, and other electrical devices to assist the operator in his quest for assistance or even emergency rescue.

In an exemplary embodiment, the adaptive vehicle power system includes electronic switching and sensing circuitry, enclosed in a portable case or enclosure, with a cable harness extending from the enclosure, or in other versions with connectors embedded in the case with no exposed cable harnesses, both with exposed connector ends for connecting to a mating connector from a cable harness which would then attach to the individual batteries of the battery bank for the Trolling motor, the boat's drive motor battery(s), and to the Trolling motor itself. Each Trolling motor battery in the system, the boat's drive motor battery(s), and the Trolling motor itself, shall have its own independent interconnection cable harness for the positive and negative electrical terminals of each. The adaptive vehicle power system shall receive the standard positive and negative electrical terminations from each connection point within its control switching system, including the positive and negative electrical termination from the Trolling motor, the positive and negative electrical terminations from each individual Trolling motor (load) battery(s) (or bank of batteries), the positive and negative electrical terminations from each individual drive motor battery(s) (or bank of batteries) or the positive and negative electrical terminations from the drive motor itself, and the adaptive vehicle power system will internally provide the switching of all the battery electrical systems, motors and accessories, into series or parallel mode as required by the operator or as controlled by the automatic sensing system. The adaptive vehicle power system can also include and perform the enabling or disabling of the operation of the Trolling motor (or load), or other specific systems or outputs, depending on the state of the system, which can also be controlled via a manual switch or a key lock security switch mechanism or by other means, including wireless interface of control and data to a remote device such as a smart phone or remote control, including data logging and recording of the systems use and power discharged and charged over time or duration of use.

In this exemplary embodiment, a first voltage display on the front panel of the enclosure displays the voltage of the boat's drive motor battery/electrical system and a second voltage display on the front panel of the enclosure displays the voltage of the Trolling motor's battery bank. A push button switch allows selective operation of the display(s) by a user. This data can also be controlled and transferred by other means via wireless interface to a receiving device. Additional voltage displays may be added, to output the voltage (or state of charge) of each of the individual batteries which may be configured in a bank of batteries. Other displays and data gathering devices can be used to display the proper function of not only the devices or accessories being controlled, but can be used to show the current state of the adaptive vehicle power system and can monitor and output the switching configuration of all the devices or energy storage devices interconnected within the system itself to display and confirm to the user of all systems functioning properly or display if there is a fault or a problem within the system. Battery management systems may also be included within the adaptive vehicle power system to ensure the proper charging of the individual batteries within the system and to ensure the proper balancing of the batteries within the system for maximum performance and safe operation by the operator.

In another exemplary embodiment, a “boost” push button on the front panel of the display allows the temporary connection of one or more batteries of the Trolling motor battery bank to connect to the boat's drive motor electrical system to allow, for example, the emergency jump starting of the boat's drive motor. Normal activation of this “boost” switch causes the internal switching mechanism of the adaptive vehicle power system to configure the Trolling motor bank of batteries to be switched from series electrical configuration to a parallel electrical configuration, matching the voltage of the boat's drive motor electrical system, and allowing the reserve power from the Trolling motor bank of batteries to be used in reverse, thus powering the boat's drive motor starter system to emergency jump start the system and this will be confirmed by the digital volt meter displays showing voltages, virtually matching each other. This switching mechanism can also be monitored and controlled by other means, including wireless interface to a remote transponder device, smart phone, etc.

### DESCRIPTION OF THE DRAWINGS

Illustrative embodiments of the invention are described in detail below with reference to the attached drawing figures, and wherein:

FIG. 1 is a perspective view of an adaptive vehicle power system in accordance with an exemplary embodiment of the present invention.

FIG. 2 is a schematic diagram of control and switching circuitry of an adaptive vehicle power system in accordance with an exemplary embodiment of the present invention.

FIGS. 3A through 3D are schematic diagrams of the wiring harness of the adaptive vehicle power system of FIG. 1, depicting attachment to the individual batteries of a Trolling motor battery bank and to the battery(s) of a boat's drive motor electrical system.

### DETAILED DESCRIPTION

The subject matter of select embodiments of the invention is described specificity herein to meet statutory requirements. But the description itself is not intended to necessarily limit the scope of claims. Rather, the claimed subject matter might be embodied in other ways to include different components, steps, or combinations thereof similar to the ones described in this document, in conjunction with other present or future technologies. Terms should not be interpreted as implying any particular order among or between various steps herein disclosed unless and except when the order of individual steps is explicitly described. The terms “about” or “approximately” as used herein denote deviations from the exact value in the form of changes or deviations that are insignificant to the function.

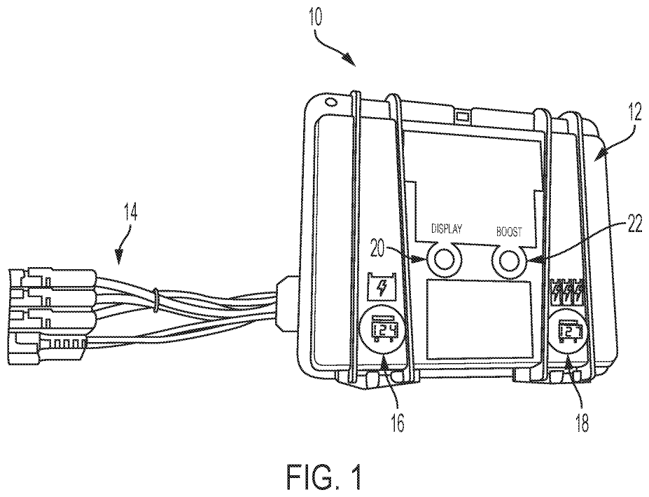

Looking first to FIG. 1, an adaptive vehicle power system in accordance with a first exemplary embodiment of the present invention is depicted generally by the numeral 10. In this embodiment, the adaptive vehicle power system 10 generally comprises an enclosure 12, with a cable harness 14 extending from one side of the enclosure 12 for connection of the adaptive vehicle power system 10, to a Trolling motor and to the individual batteries of the battery bank of a Trolling motor, and to the battery of a boat's drive motor electrical system. In this embodiment, the enclosure 12, with extending cable harness 14, are constructed to be waterproof, due to their use environment, however any structural configuration can be used for normal operation of the system as long as the electrical connections are made.

A first voltage display 16 is positioned on the front panel of the enclosure 12 and is operable to display the voltage of the boat's drive motor battery(s) connected to the adaptive vehicle power system 10. A second voltage display 18 is similarly positioned on the front panel of the enclosure 12 and is operable to display the voltage of the Trolling motor battery bank connected to the adaptive vehicle power system 10.

A “display” pushbutton 20 located on the front panel of the enclosure 12 allows an operator to selectively command the display of voltages on the first and second voltage displays 16, 18. A “boost” pushbutton 22 located on the front panel of the enclosure 12 allows an operator to selectively command the control circuitry located in the enclosure (as will be described in more detail below) to provide power from one or more batteries of the Trolling motor battery bank to the boat's drive motor battery(s), to be used, as example, in attempting to jump start the boat's drive motor if the boat's drive motor battery is depleted.

It should be understood that while the exemplary embodiment depicted herein discusses a thirty-six volt Trolling motor battery bank (comprising three twelve volt batteries connected in series), that the adaptive vehicle power system of the present invention may equally be configured and employed to work in conjunction with systems having other voltage combinations. For example, the adaptive vehicle power system may be used in connection with a twenty-four volt Trolling motor battery bank (comprising two twelve volt batteries) and a twelve volt vehicle battery and electrical system.

It should be further understood that the system of the present invention may be used in conjunction with other types of vehicles, other than boats, and with vehicles having other base-level voltage systems, and with battery banks for other purposes than for use with Trolling motors. For example, the adaptive vehicle power system may be used with a vehicle having a six volt electrical system and an accessory item having a twelve volt or eighteen volt battery bank.

One skilled in the art will recognize that the power system of the present adaptive vehicle power system invention may be easily configured to operate with any similar combination of vehicle and battery bank voltages, wherein the batteries are configured to step-up or step-down the voltage to be used by the load. Thus, the embodiments described herein should be understood to be merely illustrative and not limiting as to the applications with which the present invention may be employed.

It should also be understood that the battery(s) and battery banks discussed herein may be any type of energy storage, energy producing (solar panels), and energy discharging components or devices known in the art, such as batteries, including lead-acid batteries, absorbent glass mat (AGM) batteries, lithium batteries, or nickel cadmium (NiCad) batteries, or other energy storage devices, such as capacitors, super-capacitors, ultra-capacitors and the like, and the present invention is not limited to use with just batteries.

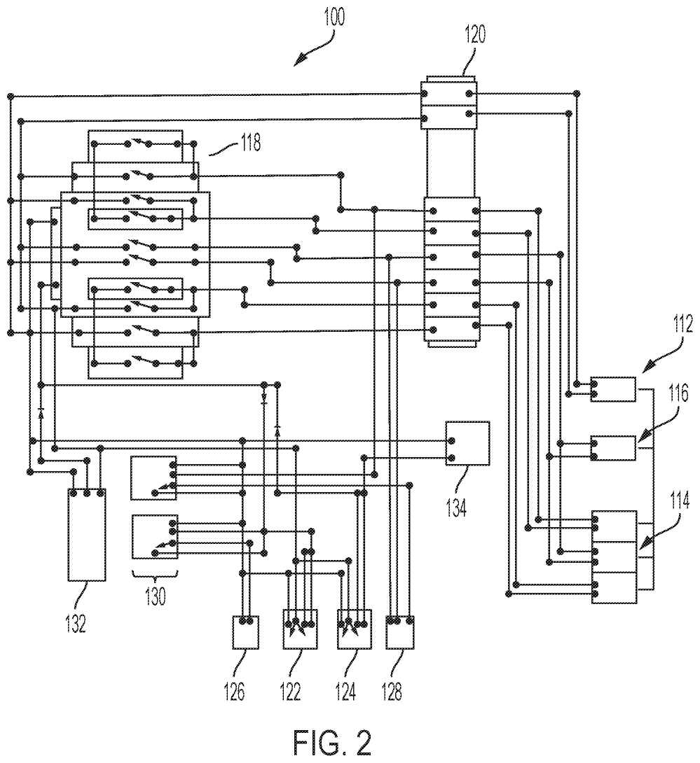

Looking to FIG. 2, in an exemplary embodiment and configuration of the present invention, an adaptive vehicle power system in accordance with a first exemplary embodiment of the present invention is depicted generally by the numeral 100. The adaptive vehicle power system 100 generally comprises a battery connector 112 for connection to the battery of a boat drive motor and/or to the boat's electrical system, a battery bank connector(s) 114 for connection to the battery bank used by the Trolling motor, and an output power connector 116 for connection to the Trolling motor itself.

The battery connector 112, battery bank connector(s) 114, and output power connector 116 may be any type of connector adapted to attach to wiring harnesses, cables, cable harnesses, or equipment as desired by the user or operator of the adaptive vehicle power system 100. For example, the connectors may be an Anderson brand style heavy duty quick disconnect connector, a CATPLUG brand connector, NATO Military Vehicle Slave connector, or any other type of connector known in the art that can transfer, in most cases, high power electricity. Preferably, the connectors 112, 114, 116 are configured to mate with a wiring harness (such as harness 14 as discussed with respect to FIG. 1) to allow easy connection of the power system to the boat motor drive battery(s), Trolling motor bank of battery(s), and Trolling motor itself. In this example, the cable harness connections for connection to the individual battery terminals shall be ring terminals of appropriate size to mate properly with the battery(s) used in such applications or connection terminals of other sorts as required by the application.

Looking still to FIG. 2, connectors 112, 114, and 116 are in electrical communication with conversion switch 118 via terminal blocks 120 which facilitate internal and interconnecting wiring of the power system. Conversion switch 118 selectively interconnects the batteries of the Trolling motor power bank and the boat drive motor battery/boat electrical and charging system such that the batteries of the Trolling motor bank of batteries are charged from the boat's electrical and charging system. It should be understood that the conversion switch 118 depicted in the figures includes auxiliary/additional conversion switching circuitry that may be added or deleted to configure systems with battery banks having more or fewer batteries—e.g., a twenty-four or forty-eight volt battery bank, etc.

Switches 122 and 124 correspond to the display and boost switches 16, 18, respectively, as discussed with respect to FIG. 1. The display switch 122 is operable to activate the voltage displays 126, 128 which provide a readout of the voltage levels of the boat battery and the Trolling motor battery bank, respectively. Thus, an operator desiring to view the voltage levels of the interconnected bank of batteries can simply press the display button to activate and read the voltage levels of each battery bank or in another variance of this circuitry read the voltage of each battery within the system.

Switches 122 and 124 may be any type of switch or switching mechanism known in the art, including, but not limited to, toggle switches, rocker switches, pushbutton switches, digital switches, relays, programmable logic controllers (PLCs), remote control switches, or any other switching or actuating device. The switches may be maintained for direct switching “OFF” and “ON” or the switches may be momentary to not only switch the circuitry “OFF” and “ON”, but to activate additional control circuitry that may active a delay timer that would allow for an automatic shut “OFF” of the system after a pre-set time delay had been reached, or the switches may be configured in a wireless fashion for remote control of the system through a wireless interface to a smart phone or other remote device that can be controlled and operated by the operator.

The boost switch 124 is operable to activate and configure the conversion switch 118 via relays 130 such that one or more of the batteries of the Trolling motor battery bank are connected to the boat battery. Thus, as instigated by an operator or user of the power system, the Trolling motor battery bank can be used to jump start the boat drive motor, through the drive motor battery interface.

Voltage sensing unit 132 is operable to detect the voltage level at the conversion switch. The voltage sensing unit may be any one of various devices, such as Automatic Power Off/On units, digital voltage sensing relays, voltage sensing contactors, voltage sensor blocks, and the like.

Alarm 134 is operable to activate an alarm to the user in the event of various abnormalities or malfunctions detected, included but not limited to over voltage conditions, under voltage conditions, short circuits, open circuits, overheating, and over current conditions. The alarm may be audible, visual, or combinations thereof, including ringers, piezo electric buzzers, incandescent or LED indicators, or other alarm devices as known in the art. The Alarm may also be interconnected to the control circuitry of the adaptive vehicle power system to disable or disarm certain systems from being used or operated, due to a recognized fault in the system. The alarm could also be used to alert the user to a specific state of operation of the unit. For example, in the ‘boost’ emergency jump start mode the alarm may provide a beeping sound during this operation to alert the user that the unit is in that mode and will need to be manually switched “Off” after the emergency jump start attempt has been made.

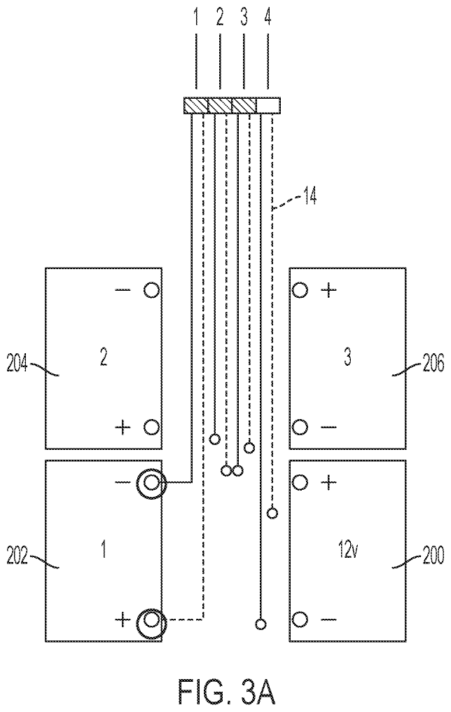

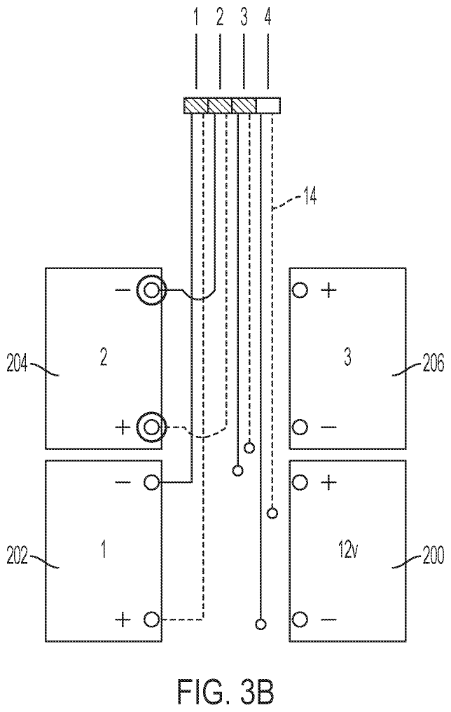

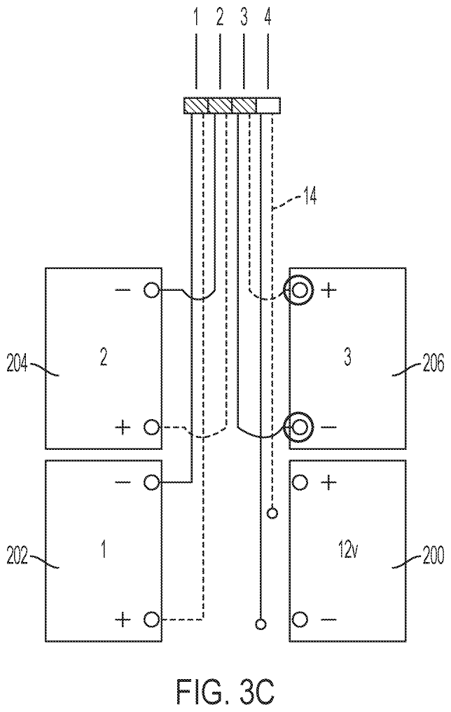

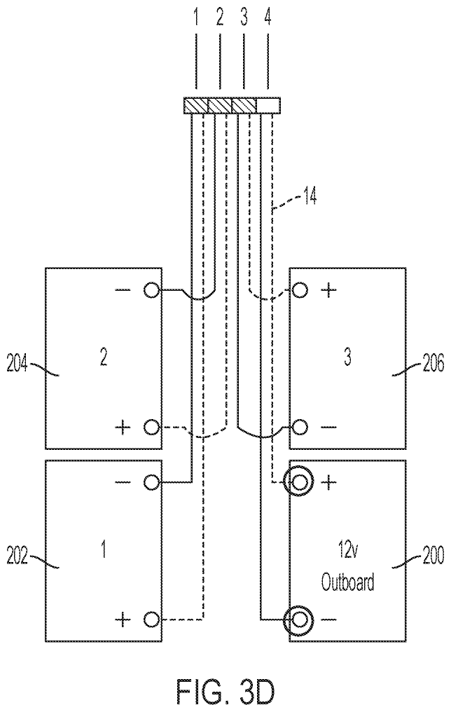

Looking to FIGS. 3A through 3D, an exemplary connection of the wiring harness 14 (as depicted in FIG. 1) to a boat battery 200 and a plurality of batteries comprising the Trolling motor batteries 202, 204, 206 is depicted. FIG. 3D shows connection of the harness to the boat battery 200, while FIGS. 3B through 3C show connections of the harness to each of the batteries 202, 204, 206 comprising the Trolling motor battery pack. Please note the two wire simplicity of the interconnection of the system, with individual positive and negative wiring from each individual component and its direct connector attachment to the adaptive vehicle power system.

In operation, the adaptive vehicle power system attaches directly to the drive motor battery of a boat (or other separate vehicle) via a cable harness, and also to each of the (single or) multiple batteries of a Trolling motor battery pack (or other accessory item battery(s) pack). When the boat's drive motor is operated, control sensor and control circuitry within the adaptive vehicle power system selectively switches the boat's drive motor battery(s) (and thus the associated charging current available to the boat's drive motor battery via the boat's drive motor charging system) to communicate with the now voltage matching battery(s) of the Trolling motor (electrical load) battery pack. When connected in this manner, the system thus charges the battery(s) of the Trolling motor battery pack using the boat's drive motor charging system. In this aspect, the Trolling motor itself is disabled from the system and cannot and will not operate when the system is in charge mode.

When not in use for charging the accessories battery pack, in this example, the adaptive vehicle power system switches the Trolling motor battery power pack, back to its series circuit configuration, placing the batteries in thirty-six volt mode (in this example) and enabling the Trolling motor for connecting to the thirty-six volt battery power pack, so that the Trolling motor can now be operated properly by the user.

The system thus allows convenient use and charging of the Trolling motor battery pack from the boat's system, without requiring returning to the dock, mooring, or land, to charge the Trolling motor batteries from land based utility power as is common with systems and configurations known in the art.

The adaptive vehicle power system also allows for and has the ability to use a separate host vehicle for its operation. With a separate electrical connection, or paralleled connection to the boat's drive motor electrical system, the same results of control and charging of the boat's drive motor battery system and Trolling motor's battery system can be achieved using the alternation/generator charging system of the separate host vehicle, i.e. another boat, towing vehicle, car, or other similar 12 volt electrical system. In this example, an interconnection to the adaptive vehicle power system can be made to any similar voltage host vehicle by means of an interconnecting cable or the use of jumper cables attached to the battery system of the host vehicle.

When the host vehicle motor is operated the adaptive vehicle power system will monitor and verify proper voltage and automatically switch its internal control system into charging mode, as it would if being powered by the boat's drive motor. With a supplied interconnecting cable, or interconnecting jumper cables, an operator can easily interconnect his boat to another boat or another separate host vehicle for power. While the operator's boat is trailered, either stationary or being transported, an interconnecting cable can be run from the boat interconnection point, along the trailer and attached to the rear of the transport vehicle. This interconnection will allow the boat's drive motor battery system and the boat's Trolling motor battery system to be charged while connected to the separate host vehicle and during transport. This same technology can be utilized by larger more powerful electrical systems in applications such as campers and recreational vehicles wherein their battery power systems can be charged during transport to their destination. This external connection to the adaptive vehicle power system also allows for the use of a separate AC powered electric battery charging system that can be on board the vessel or used separately, wherein land based utility power can be used through a charging system to replenish and recharge the various battery systems within the adaptive vehicle power system. Interface cable harnesses and connectors are used for easy interface with the adaptive vehicle power system.

In larger electrical power systems such as locomotive train motors, electric vehicles, and large emergency backup generator motors, these systems operate on various voltages, like forty-eight volts, sixty volts, and seventy-two volts to name a few, the adaptive vehicle power system, through its switching circuitry, will match the specific voltage required by these external electrical systems and can then provide power to that system for proper operation, or draw power from that system to recharge the battery systems of the adaptive vehicle power system, including any interconnected electrical load battery system. Although higher powered, these systems will use heavier contacts and cabling to account for the necessary power throughput required by the system, but from a functional perspective, the adaptive vehicle power system will operate in the same manner as previously described for the invention, no matter how big or small the interconnected system may be.

It is to be understood that the disclosed embodiments herein are merely exemplary of the invention, which may be embodied in various forms and enclosures, configured in various ways to accommodate the application. Therefore, specific structural and functional details disclosed herein are not to be interpreted as limiting, but merely as a basis for the claims and as a representative basis for the teaching of one skilled in the art to variously employ the present invention configured in virtually any appropriate detailed structure.

Many different arrangements of the various components depicted, as well as components not shown, are possible without departing from the scope of the claims below. Embodiments of the technology have been described with the intent to be illustrative rather than restrictive. Alternative embodiments will become apparent to readers of this disclosure after and because of reading it. Alternative means of implementing the aforementioned can be completed without departing from the scope of the claims below. Identification of structures as being configured to perform a particular function in this disclosure and in the claims below is intended to be inclusive of structures and arrangements or designs thereof that are within the scope of this disclosure and readily identifiable by one that is skilled in the art and that can perform the particular function in a similar way. Certain features and sub-combinations are of utility and may be employed without reference to other features and sub-combinations and are contemplated within the scope of the claims.

What is claimed is:

1. An adaptive vehicle power system, comprising:
switching circuitry in communication with a vehicle drive motor battery system; and
a motor and dedicated battery bank in communication with the switching circuitry such that a power/charging system connected to the vehicle may be selectively switched to provide power and/or charging voltage and amperage from the vehicle charging system to the dedicated battery bank.

2. The adaptive vehicle power system of claim 1, wherein the switching circuitry is manually or automatically controlled via sensing and monitoring circuitry configurable to provide a desired output voltage and power based on a user selection.

3. The adaptive vehicle power system of claim 1, wherein the switching circuitry is configured to connect the vehicle drive motor battery system and the battery bank in series connection, parallel connection, and combinations thereof.

4. The adaptive vehicle power system of claim 3, further comprising sensing circuity operable current, voltage, power, and combinations thereof of the vehicle drive motor battery system and the battery bank.

5. The adaptive vehicle power system of claim 4, wherein the sensing circuitry is operable to communicate desired settings to the switching circuitry to cause connection of the vehicle drive motor battery system and battery bank to achieve a desired voltage, current, or power output.

6. The adaptive vehicle power system of claim 5 wherein the sensing circuitry is operable to enable or disable connections to the vehicle drive motor battery system and battery bank.

7. The adaptive vehicle power system of claim 1, wherein the switching circuitry is operable to connect, disconnect, or isolate the vehicle drive motor battery system and the battery bank.

8. The adaptive vehicle power system of claim 7, wherein the switching circuitry is operated manually by a user or electronically by control circuitry.

9. The adaptive vehicle power system of claim 1, wherein the switching circuitry comprises relays, solenoid, rotary switches, solid state relays, field effect transistors, and combinations thereof.

10. The adaptive vehicle power system of claim 1, wherein the battery bank is chargeable via connection to an external land-based power system comprising coal, gas, solar, hydro, or wind based power systems.

11. The adaptive vehicle power system of claim 1, where the switching circuitry is configured to connect individual batteries of the battery bank in series or parallel to match the voltage of the vehicle's drive motor system.

12. The adaptive vehicle power system of claim 11, wherein the battery bank is configured to connect to the vehicles drive motor battery system to provide increased power capacity.

13. The adaptive vehicle power system of claim 11, wherein the switching circuitry is operable to connect the drive motor battery system and the battery bank to match a voltage of an external power supply such that the batteries of each system are charged and to provide reverse power.
